(19) United States
(12) Patent Application Publication
(10) Pub. No.: US 2015/0363761 A1
(43) Pub. Date: Dec. 17, 2015

(54) WIDGET FOR PROMOTING PAYMENTS VIA A PERSON-TO-PERSON (P2P) PAYMENT RAIL

(71) Applicant: Bank of America Corporation, Charlotte, NC (US)

(72) Inventors: David M. Grigg, Rock Hill, SC (US); James Gregory Ronca, Decatur, GA (US); Henry J. Chou, Cornelius, NC (US); Joseph Neil Johansen, Rock Hill, SC (US); Michael E. Toth, Charlotte, NC (US)

(21) Appl. No.: 14/457,908

(22) Filed: Aug. 12, 2014

Related U.S. Application Data
(60) Provisional application No. 62/012,736, filed on Jun. 16, 2014.

(51) Int. Cl. G06Q 20/22; G06Q 20/10

(52) U.S. Cl. CPC G06Q 20/223; G06Q 20/102

(57) ABSTRACT

Systems, apparatus, and computer program products are provided for promoting payment via a Person-to-Person (P2P) payment rail through use of a widget embedded in or accessible through a web page, application, electronic document, text message or the like.

### CROSS-REFERENCE TO RELATED APPLICATIONS

This application claims priority to U.S. Provisional Patent Application Ser. No. 62/012,736, filed Jun. 16, 2014, entitled “A Widget for Promoting Payments via a Person-to-Person (P2P) Payment Rail,” the entirety of which is incorporated herein by reference.

### INCORPORATION BY REFERENCE

To supplement the present disclosure, this application further incorporates entirely by reference the following commonly assigned patent application entitled, “Person-to-Person (P2P) Payments via a Short-range Wireless Payment Beacon”, Attorney Docket No. 6319US1.014033.2294, U.S. patent application Ser. No. ______, filed concurrently herewith.

### FIELD

In general, embodiments of the invention relate to commerce and, more particularly, to promoting payment via a Person-to-Person (P2P) payment rail through the use of a widget embedded or accessible in a web page, a mobile application, an electronic document, a text message or the like.

### BACKGROUND

Small businesses, charities or the like are always looking for ways to make payment easier for customers and/or donors and at the same time defer costs. While customers/donors have typically chosen to make such payments/donations with a credit card, the business or charity bears the burden of the financial fee associated with accepting such credit card payments.

Therefore, a need exists to develop systems, apparatus, methods, computer program products and the like that make it convenient for customers and donors to make payments/donations, while maximizing the profitability for the business or charity.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing systems, methods, computer program products or the like for promoting payment via a Person-to-Person (P2P) payment rail (otherwise referred to as account-to-account payment rail) using a widget embedded or accessible within a web page, a mobile application (i.e., an “app”), an electronic document (e.g., an invoice or the like), a Short Message Service (SMS)/text message or the like. In such embodiments of the invention, the business, charity, event provider may configure the widget as an icon on a webpage, within an app, in an electronic document or the like, which notifies the customer/donor or the like that the business or charity accepts P2P payment (i.e., typically, a direct debit from a customer-identified bank account). The icon may be configured by the widget provider to be displayed in any shape or size and to be located in any position on the web page. Once the customer/donor activates the icon, the widget allows the registered P2P payment user to enter a payment/donation amount and their credentials (i.e., ID/passcode, such as a telephone number or the like) to authorize payment. If the user is an unregistered P2P payment user, the widget may direct the user to a P2P payment enrollment mechanism. Process of the payment involves verifying that the user is a registered P2P participant and determining the payment account or payment vehicle that the user has designated for P2P payments.

Further, embodiments of the invention provide for coding or identifying the P2P payment so that the business/donation knows which financial account the payment should go to and/or what the circumstances surrounding the payment are (i.e., specific event, specific charity or the like), so that the payment can be properly identified in the payee's designated account.

As such, the present invention affords customers/donors an easy option for making payments/donations and provides the business/charity with an alternative payment rail that may lessen or eliminate the fees associated with accepting credit card payments or the like.

A system for executing a person-to-person (P2P) payment defines first embodiments of the invention. The system includes a computing platform having a memory and at least one processor in communication with the memory. The system additionally includes a person-to-person (P2P) payment widget stored in the memory and executable by one of the processors. In specific embodiments the widget is a web widget embedded within a web page (e.g., an e-commerce site, a gift registry site or the like), in other embodiments the widget may be embedded or accessible through a mobile application, embedded or accessible through an electronic document, such as an invoice or accessible through a link in a text message, email or the like. The widget is configured to (1) receive a first input from a user that selects the widget, (2) in response to receiving the first input, provide display of input fields for a payment amount and P2P payment credentials, (3) receive a second input that defines the payment amount and the P2P payment credentials of the user and (4) initiate electronic communication of a payment request including the payment amount and P2P payment credentials. In specific embodiments, the payment request may additionally identify the payee account or include payment attribute data (e.g., a unique identifier for a specific charity, a specific event, a specific purchase) that attaches to the payment as metadata or the like, such that payee can identify the payment, the payment source or the payment purpose once the payment is in the payee account.

The system additionally includes a P2P payment processing module stored in the memory, executable by one of the processors. The P2P payment processing module may be executed on a P2P payment server and/or at a cloud level. The P2P payment processing module is configured to (1) receive the payment request, (1) validate the user as a registered P2P payment participant based on the P2P payment credentials, (2) determine the payment account designated by the user for paying the payment amount, (3) determine a payee account for receiving the payment amount, and (4) initiate immediate remittance of the payment amount from the payment account to the payee account. In specific embodiments the payee account may be determined based on identification of the payee account or in the payment request (i.e., received from the widget), or an identifier in the payment request.

A computer program product including a non-transitory computer-readable medium defines second embodiments of the invention. The computer readable medium includes a first set of codes for causing a first computer to receive a first input from a user that selects a Person-to-Person (P2P) payment widget and a second set of codes for causing the first computer, in response to receiving the first input, provide display of at least one input field configured to receive P2P payment credentials. The computer readable medium additionally includes a third set of codes for causing the first computer to receive a second input that defines P2P payment credentials of the user and a fourth set of codes for causing the first computer to initiate electronic communication of a payment request including a payment amount and P2P payment credentials. In addition, the computer-readable medium includes a fifth set of codes for causing a second computer to (1) receive the payment request, (2) validate the user as a registered P2P payment participant based on the P2P payment credentials, (3) determine the payment account designated by the user for paying the payment amount, (4) determine a payee account for receiving the payment amount, and (5) initiate immediate remittance of the payment amount from the payment account to the payee account.

A method for executing a person-to-person (P2P) payment defines third embodiments of the invention. The method includes receiving, at a computing device, a first input from a user that selects a P2P payment widget and, in response to receiving the first input, providing, by a computing device processor, display of at least one input field configured to receive P2P payment credentials. The method further includes receiving, by a computing device processor, a second input that defines P2P payment credentials of the user, initiating, by a computing device processor, electronic communication of a payment request including a payment amount and the P2P payment credentials. Further, the method includes receiving, by a computing device processor, the electronic communication including the payment request and, in response to receiving the electronic communication: (1) validating, by a computing device processor, the user as a registered P2P payment participant based on the P2P payment credentials, (2) determining, by a computing device processor, the payment account designated by the user for paying the payment amount, (3) determining, by a computing device processor, a payee account for receiving the payment amount; and (4) initiating, by a computing device processor, immediate remittance of the payment amount from the payment account to the payee account.

Thus, systems, apparatus, methods, and computer program products herein described in detail below provide for promoting payment via a P2P payment rail through the use of a widget that is embedded in a webpage and/or accessible through a mobile application, electronic document, text message or the like.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a block diagram of an apparatus configured for promoting payment via a person-to-person/account-to-account payment rail using a widget, in accordance with embodiments of the present invention;

FIG. 2 provides a schematic diagram of a system configured for promoting payment via a person-to-person/account-to-account payment rail using a widget, in accordance with embodiments of the present invention; and

FIG. 3 provides a flow diagram of a method for promoting payment via a person-to-person/account-to-account payment rail using a widget, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution,” one of ordinary skill in the art will appreciate that the invention may be utilized by other businesses that take the place of or work in conjunction with financial institutions to perform one or more of the processes or steps described herein as being performed by a financial institution.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Perl, Smalltalk, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

According to embodiments of the invention described herein, various systems, apparatus, methods, and computer program products are herein described for promoting payment via a Person-to-Person (P2P) payment rail (otherwise referred to as an account-to-account payment rail) using a widget embedded or accessible within a web page, a mobile application (i.e., an “app”), an electronic document (e.g., an invoice or the like), a Short Message Service (SMS)/text message or the like. In such embodiments of the invention the business, charity, event provider or the like may configure the widget as an icon on a webpage, within an app, in an electronic document or the like, which notifies the customer/donor or the like that the business, charity, event provider accepts P2P payment (i.e., typically, a direct debit from a customer-identified bank account). Once the customer/donor activates the icon, the widget allows the registered P2P payment user to enter a payment/donation amount (or confirm the payment amount) and their credentials (i.e., ID/passcode, such as a telephone number or the like) to authorize payment. If the user is an unregistered P2P payment user, the widget may direct the user to a P2P payment enrollment mechanism. Process of the payment involves verifying that the user is a registered P2P payment participant and determining the payment account or payment vehicle that the user has designated for P2P payments.

Further, embodiments of the invention provide for coding or identifying the P2P payment so that the business/donation knows which financial account the payment should go to and/or what the circumstances surrounding the payment are (i.e., specific event, specific charity or the like), so that the payment can be properly identified in the payee's designated account.

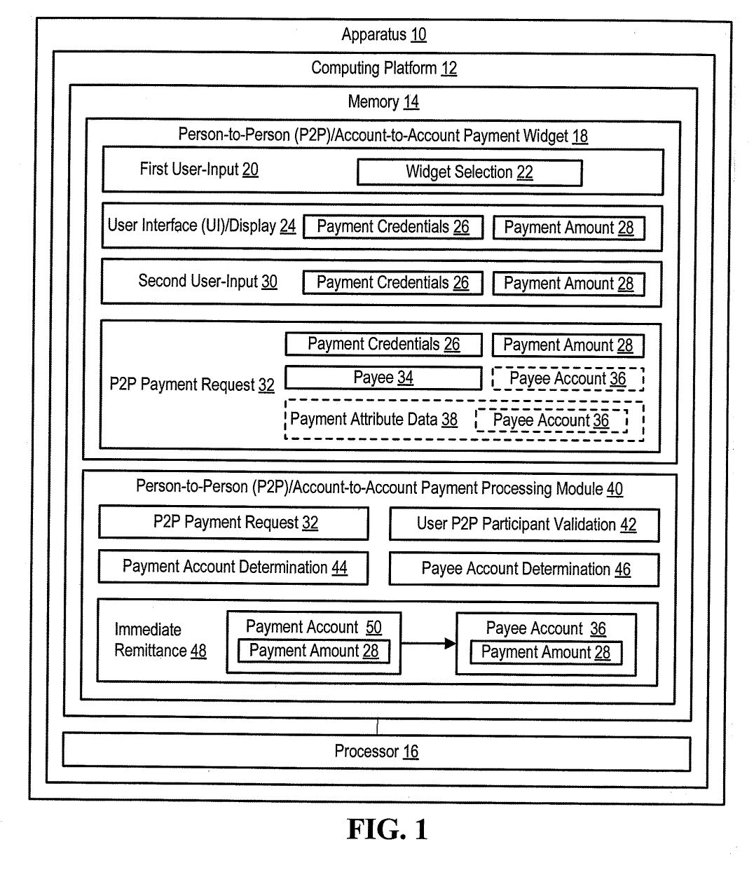

Referring to FIG. 1, block diagram is presented of an apparatus 10 configured for promoting payment via a P2P payment rail using a widget embedded or accessible through a web page, an application (e.g., mobile app), an electronic document or the like, in accordance with embodiments of the present invention. The apparatus 10 which may include more than one physical device or unit is operable to receive and execute modules, routines and applications, such as person-to-person (P2P) payment widget 18, P2P payment processing module 40 and the like.

The apparatus 10 includes a computing platform 12 that can receive and execute routines and applications. The computing platform 12 includes memory 14, which may comprise volatile and nonvolatile memory such as read-only and/or random-access memory (RAM and ROM), EPROM, EEPROM, flash cards, or any memory common to computer platforms. Further, memory 14 may include one or more flash memory cells, or may be any secondary or tertiary storage device, such as magnetic media, optical media, tape, or soft or hard disk.

Further, the computing platform 12 also includes at least one processor 16, which may be an application-specific integrated circuit (“ASIC”), or other chipset, processor, logic circuit, or other data processing device. Processor 16 or other processor such as ASIC may execute an application programming interface (“API”) layer (not shown in FIG. 1) that interfaces with any resident programs, such as person-to-person (P2P) payment widget 18, P2P payment processing module 40 and the like, stored in the memory 14 of apparatus 10. Processor 16 includes various processing subsystems (not shown in FIG. 1) embodied in hardware, firmware, software, and combinations thereof, that enable the functionality of apparatus 10 and the operability of the apparatus on a network. For example, processing subsystems allow for initiating and maintaining communications, and exchanging data, with other networked devices. Additionally, processing subsystems may include any portion of the functionality of comparable person-to-person (P2P) payment widget 18, P2P payment processing module 40 obviating the need for such applications and modules to be stored in the memory 14.

The memory 14 of apparatus 10 stores P2P payment widget 18, otherwise referred to as an account-to-account payment widget that is configured to promote payment using the P2P payment rail. The widget 18 may be embedded within a webpage, such as a business web page, a charity webpage, an event webpage or the like. The widget 18 may take the form of an icon on the webpage that notifies the user that the business, charity, event or the like accepts direct-financial account (e.g., direct deposit account or the like) payment. In other embodiments of the invention, the widget 18 may be included in an application, such as a mobile “app” or the like. The app may be specific to a business, a charity an event or the like. In other embodiments of the invention the widget 18 may be embedded in an electronic-document, such as an electronic invoice (e-invoice), that notifies the recipient of the invoice that that the sender (i.e., the business, charity or the like sending the invoice) accepts P2P payment and providing an initiation point for such payments. In other embodiments of the invention, the widget may be accessible through a hyperlink that can be communicated in an electronic communication, such as a Short Message Service (SMS)/text message, electronic mail (i.e., email), or the like. Additionally, the hyperlink can be displayed on social media sites to promote payment using a P2P payment rail.

According to embodiment of the present invention, the P2P payment widget 18 is configured to receive a first user-input 20 that selects 22 the widget. For example, if the widget is embedded in a webpage the first user-input 20 may be activating the icon associated with the widget 18 or, similarly, if the widget 18 is embedded in an e-invoice the first user-input 20 may be activating an icon or similar identifier associated with the widget 18. In other examples, in which the widget is included within an app (e.g., a stand-alone payment app or a generic app, such as a mobile banking application, online retailer app or the like) the first user-input may be predicated on the user activating the application and, subsequently providing the first user-input 20 to select/activate the widget within the application. Further, the first user-input 20 may include activating a hyperlink that directs the user to the widget 18.

In response to receiving the first user-input 20, the widget 18 is configured to provide a display/user interface 24 that includes a payment amount 28 entry field and a payment credentials 26 entry field. In specific embodiments of the widget 18, the payment amount entry field may, upon display, have a fixed payment amount already entered, based on a predetermined payment amount (e.g., purchase of a specific item(s) or service), fixed donation amount, fixed event entry fee or the like. The payment credential 26 entry field may be configured to receive a username (i.e., ID) and passcode/password or a single payment credential, such as a user-designated telephone number, or some other readily remembered identifier/passcode. Additionally, the widget 18 may be configured such that the user selects the designated purpose for the payment (e.g., a drop down menu listing events, specific charities or the like) (not shown in FIG. 1).

It should be noted that P2P payment users are registered users that have previously designated at least one payment account 28 and have previously set-up their payment credentials 26. In the event that a user that activates the widget is not a registered P2P payment user, the widget may provide for directing the user to an enrollment site, which allows for the user to enroll in a P2P payment program, typically on-the-spot enrollment that provides for the user to designate at least one payment account 28 and identify their payment credentials 26. Thus, widget 18 is further configured to receive second input 30 that includes the payment credentials 26 and, in some embodiments of the invention, the payment amount 28.

In response to receiving the second-user input 30, the widget 18 is configured to initiate, wireless and/or wired communication of a P2P payment request 32 that includes the payment credentials 26 and the payment amount 28. Additionally, the payment request 32 identifies the payee 34, since the widget is payee-specific, the source of the payment request (i.e., the widget from which the payment request originates) may serve to identify the payee 34. In specific embodiments of the invention, the payment request 32 may include or identify the payee account 36 (i.e., in those instances in which the payee has more than one payee account designated for receipt of P2P payments). The payment request 32 may, in some embodiments, additionally include payment attribute data 38, such as metadata or the like that identifies the payor, the specific purpose of the payment (e.g., invoice number), the specific designated charity, event or the like. The payment attribute data 38 may be used by the payee (e.g., widget provider) for reporting purposes, i.e., insure that the payor is credited for the payment and the like or the payment attribute data 38 may be used to determine which payee account 36 should receive the payment amount/funds 28. The payment attribute data 38 may attach to the payment amount 28, such that when the payment amount is made to the payee's account the payee is able to access the metadata to determine the attribute data, e.g., the payor, the purpose of the payment, a specific benefactor within a charity, a specific aspect of an event or the like. Additionally, the payment attribute data 38 may include a unique identifier for the event/charity/invoice that serves to identify the payee account 36 associated with event/charity/invoice or the like.

The memory 14 of apparatus 10 additionally includes P2P payment processing module 40, which typically is executed on a P2P payment server implementing a P2P payment cloud. The P2P payment processing module 40 is configured to receive the P2P payment request 32 and, through use of the payment credentials, validate 42 the user as a registered P2P payment participant. Once validated, the payment processing module 40 is further configured to determine the payment account 44 designated by the P2P payment user from which the payment amount 28 is to be drawn from. Determination of the payment account 44 may be based on a payment account priority preconfigured by the user. Additionally, determination of the payment account may be based on the type of payment as preconfigured by the user (e.g., charity payments from account(s) “x” and purchase payments from account(s) “y”).

It should be noted that in the event that the user has designated a credit card account as the payment account and the widget provider does accept or would prefer not to accept credit cards (so as to not incur the related fees), the P2P payment processing module 40 may communicate a message back to the user through the widget that (1) denies payment, (2) asks the user to provide other payment means, and/or (3) requires the user to accept an additional payment fee in order to use the credit card account (i.e., the user pays the fee that would otherwise be imposed on the widget-provider (i.e., vendor, charity, event provider or the like).

P2P payment processing module 40 is further configured to determine the payee account(s) 46 for receiving the payment amount 28. As previously noted in specific embodiments the widget is payee-specific (i.e., specific business, specific charity, specific event, or the like). As such, the widget that communicates the payment request 32 may serve to identify the payee and, if the payee, has only one account designated for receiving the payment account 28, the payment request 32 may, de facto, identify the payee account 36, as well. Additionally, as previously discussed, the payment request 32 may include a payee account 36 identifier or the payment attribute data 38 may include a payee account 36 identifier. In other embodiments of the invention, the determination of the payee account 36 may be made by the P2P payment processing module 40 at the payment processing server or at the cloud-level. In such embodiments, the P2P payment processing module 40 may rely on the payment attribute data 38 received from the widget 18 to determine the payor, the purpose/type of payment (e.g., charity, purchase, event or the like) or the like and, using correlation tables stored at the server or in the cloud, identify the payee account 36 associated with the payee (i.e., widget-provider), the purpose/type of payment or the like.

Once the payment account and the payee account have been determined, P2P payment processing module 40 is further configured to initiate immediate remittance of the payment amount 28 from the payment account(s) 50 to the payee account 36. Immediate remittance provides for the payment amount 28 to be debited from the payment account 50 upon receiving the payment request 32 and validating the user as a P2P payment participant and for the payee account 36 to receive and have available (i.e., no hold period) the payment amount instantaneously upon completion of the P2P payment process.

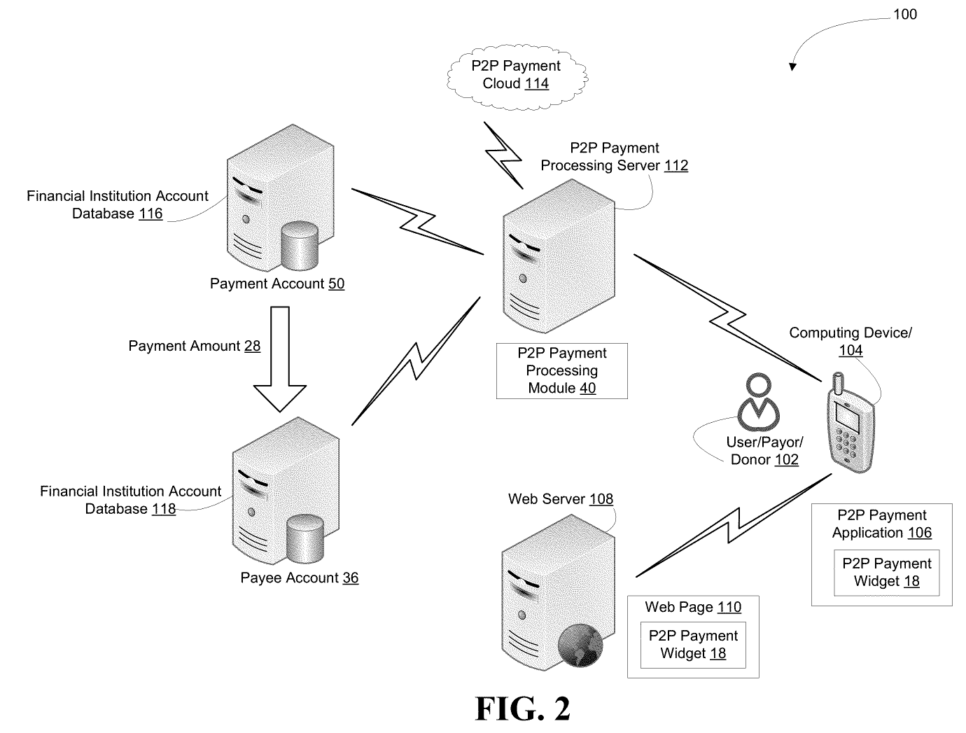

Referring to FIG. 2 a schematic diagram is provided of a system 100 for promoting payment via a P2P payment rail using a P2P payment widget, in accordance with embodiments of the present invention. The system 100 includes a P2P payment widget 18 that may be embedded in a web page 110, which is stored within a computing network, such as the Internet, at web server 108. As such the user, otherwise referred to as the payor or donor, is able to access web server 108 through network communication with computing device 104 which is in possession of user 102. While the computing device 104 is depicted as a mobile device, such as a smart telephone or the like, the computing device 104 may be any computing device capable of wired or wireless Internet communication, such as table device, laptop device, personal computer (PC) or the like.

In other embodiments of the invention, the widget 18 may be included within or accessible through a P2P payment application 106, which may be stored at and executable by the computing device 104. The P2P payment application 106 may be a stand-alone payment application or the P2P payment application 106 may be a general business-specific app (or donor-specific app, or event-specific app) that includes the widget 18 or network-access to the widget 18. As previously noted, other embodiments of the invention (not shown in FIG. 2) provide for the widget to be included in electronic-documents (e.g., e-invoices) or to be accessible as hyperlink in an electronic communication (email, text message or the like).

Once the user 102 has activated the widget 18 to pay for item(s)/service(s), make a charity donation, attend/pay for an event or the like and supplies the payment request information, such as payment amount and payment credentials (user ID and passcode/password), a payment request is communicated to P2P payment processing server 112 which, in concert with P2P payment cloud 114, executes P2P payment processing module 40. As previously, noted the payment processing module 40 receives the payment request from the P2P payment widget and validates the user as a registered P2P payment participant and determines (a) the payment account designated by the user and (b) the payee account designated by the payee (e.g., the widget-provider). The user credentials, the payment account information and, in some embodiments, the payee account information used to correspondingly validate the user, and determine payment account(s) and payee accounts(s) may be stored in the P2P payment cloud 114.

Once the payment request has been processed by the P2P payment processing module 40 (i.e., the user is validated and payment and payee accounts have been identified), immediate remittance of the funds (i.e., payment amount 28) occurs. The financial institution account database 116 associated with the payment account 50 is accessed to debit the payment amount 28 from the payment account 50 and the financial institution account database 118 associated with the payee account 36 is accessed to credit the payment amount 28 to the payee account 36. Immediate remittance provides for no delay time or hold time between debiting the payment amount 28 from the payment account 50 and crediting the payee account 36.

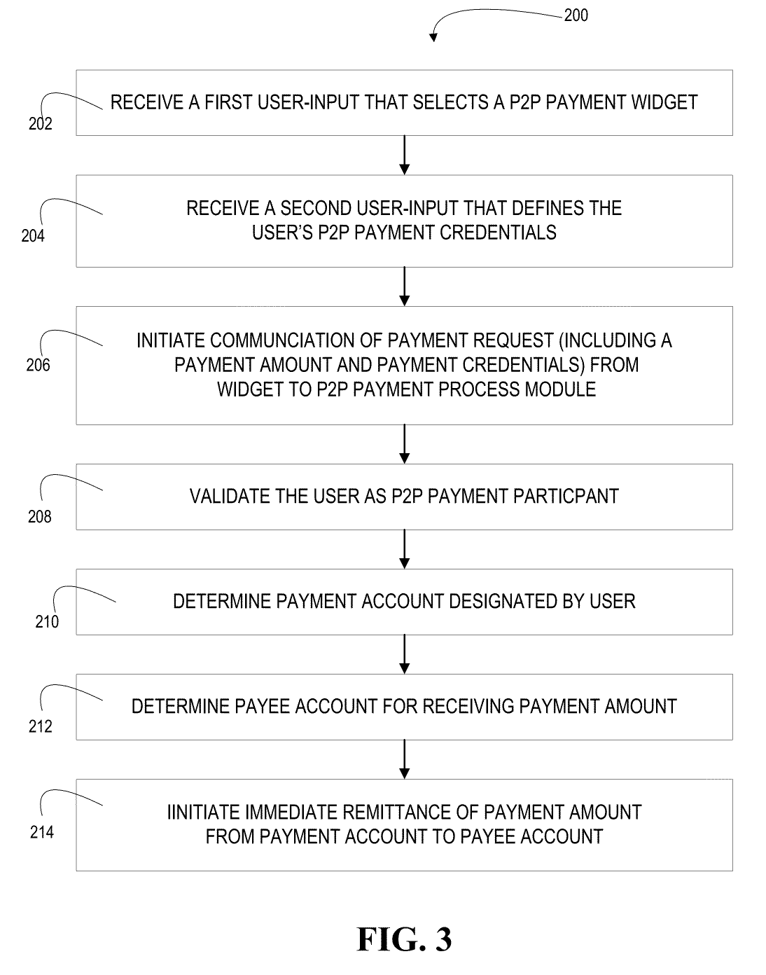

Referring to FIG. 3, a flow diagram is provided of a method 200 for promoting payment via a P2P payment rail using a P2P payment widget, in accordance with embodiments of the present invention. At Event 202, a first user-input is received that selects the P2P payment widget. As previously noted, the widget may be embedded within a web page configured as an icon or the like, accessible or within an application, such as a mobile app, embedded or accessible in an electronic document, such as an e-invoice, or included as a hyperlink within a text message, email or the like.

At Event 204, a second user-input is received at a user interface of the widget. The second user-inputs define payment credentials (e.g., user identification and passcode/password) and, in some embodiments, payment amount. In specific embodiments, the payment amount may be fixed by the widget, for example, if the purchase, donation or event is for a set amount.

In response to receiving the second user-inputs, at Event 206, a payment request is generated and electronic communication is initiated from the widget to a P2P payment processing module. The payment request includes the payment credentials, payment amount and a payee identifier. Additionally, in specific embodiments the payment request may identify the payee account or include payment attribute data, such as purpose of payment, specific purchase, charity or event data, and the like. The payment attribute data may act as metadata that attaches to the payment amount such that when the payment amount is credited to the payee account the payee can identify the source of the payment as well as the purpose of the purpose.

In response to receipt of the payment request by the P2P payment processing module, at Event 208, the user is validated as a registered P2P payment participant. In such embodiments, the P2P payment processing module, which may be executed at the server-level may communicate with a P2P payment cloud that stores the user credentials.

At Event 210, the payment account designated by the user/purchaser/donor is determined. The user may have a single payment account designated for all P2P payments or the user may have rules designated for payment account determination. The rules may call for a payment account priority based on payment account balance, time/date of transaction, payment type or the like. In other embodiments the payment credentials may define the payment account, such that the user may use one payment credentials for payment from one designated payment account and may use another payment credential for payment from another designated payment account.

At Event 212, the payee account designated by the payee (e.g., the widget-provider) is determined. The payee account(s) may be identified in the payment request or determined based on payment attribute data in the payment request. In other embodiments the payee account may be determined at the server or cloud-level based on information stored at the server or in the payment cloud. The widget provider may have multiple payee accounts, such that each payee account is associated with a specific charity, event, purchase item(s)/service(s), or some other identifiable purchase/charity characteristic.

In response to validating the user and determining the payment account and the payee account, at Event 214, immediate remittance of payment is initiated, such that the payment amount is debited from the payment account and immediately credited to the payee account, such that the funds associated with the payment amount are immediately available to the payee (e.g., widget provider) without incurring any hold period or delay time.

Thus, systems, apparatus, methods, and computer program products described above provide for provide for promoting payment via a P2P payment rail through the use of a widget that is embedded in webpage and/or accessible through a mobile application, electronic document, text message or the like.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for executing a person-to-person (P2P) payment, the system comprising:
a computing platform having a memory and at least one processor in communication with the memory;
a person-to-person (P2P) payment widget stored in the memory, executable by one of the processors and configured to (1) receive a first input from a user that selects the widget, (2) in response to receiving the first input, provide display of at least one input field configured to receive P2P payment credentials, (3) receive a second input that defines P2P payment credentials of the user, and (4) initiate electronic communication of a payment request including a payment amount and P2P payment credentials;
a P2P payment processing module stored in the memory, executable by one of the processors and configured to (1) receive the payment request, (1) validate the user as a registered P2P payment participant based on the P2P payment credentials, (2) determine the payment account designated by the user for paying the payment amount, (3) determine a payee account for receiving the payment amount, and (4) initiate immediate remittance of the payment amount from the payment account to the payee account.

2. The system of claim 1, wherein the P2P payment widget is further configured to initiate communication of the payment request that further identifies the payee account and wherein the P2P payment processing module is further configured to determine the payee account as the payee account identified in the payment request.

3. The system of claim 1, wherein the P2P payment widget is further configured to initiate communication of the payment request that further includes payment attribute data.

4. The system of claim 3, wherein the P2P payment processing module is further configured to determine the payee account based on the payment attribute data.

5. The system of claim 3, wherein the payment attribute data is attached to remittance of the payment amount from the payment account to the payee account.

6. The system of claim 1, wherein the P2P payment widget is embedded with a web page such that the widget is displayed as a selectable icon within the web page.

7. The system of claim 1, wherein the P2P payment widget is accessible through one of a mobile application, an electronic document or a text message.

8. The system of claim 7, wherein the electronic document is an invoice.

9. A computer program product comprising:
a non-transitory computer-readable medium comprising:
a first set of codes for causing a first computer to receive a first input from a user that selects a Person-to-Person (P2P) payment widget;
a second set of codes for causing the first computer, in response to receiving the first input, provide display of at least one input field configured to receive P2P payment credentials;
a third set of codes for causing the first computer to receive a second input that defines P2P payment credentials of the user;
a fourth set of codes for causing the first computer to initiate electronic communication of a payment request including a payment amount and P2P payment credentials; and
a fifth set of codes for causing a second computer to (1) receive the payment request, (2) validate the user as a registered P2P payment participant based on the P2P payment credentials, (3) determine the payment account designated by the user for paying the payment amount, (4) determine a payee account for receiving the payment amount, and (5) initiate immediate remittance of the payment amount from the payment account to the payee account.

10. The computer program product of claim 9, wherein the fourth set of codes is further configured to cause the first computer to initiate communication of the payment request that further identifies the payee account and wherein the fifth set of codes is further configured to cause the second computer to determine the payee account as the payee account identified in the payment request.

11. The computer program product of claim 9, wherein the fourth set of codes is further configured to cause the first computer to initiate communication of the payment request that further includes payment attribute data and wherein the fifth set of codes is further configured to cause the second computer to determine the payee account based on the payment attribute data.

12. The computer program product of claim 11, wherein the fifth set of codes is further configured to cause the second computer to attach the payment attribute data is to remittance of the payment amount from the payment account to the payee account.

13. The computer program product of claim 9, wherein the first set of codes is further configured to cause the first computer to receive a first input from a user that selects a Person-to-Person (P2P) payment widget that is embedded with a web page such that the widget is displayed as a selectable icon within the web page.

14. The computer program product of claim 9, wherein the first set of codes is further configured to cause the first computer to receive a first input from a user that selects a Person-to-Person (P2P) payment widget that is accessible through one of a mobile application, an electronic document or a text message.

15. The computer program product of claim 14, wherein the first set of codes is further configured to cause the first computer to receive a first input from a user that selects a Person-to-Person (P2P) payment widget that is accessible through the electronic document defined as an invoice.

16. A method for executing a person-to-person (P2P) payment, the method comprising:
receiving, at a computing device, a first input from a user that selects a P2P payment widget;
in response to receiving the first input, providing, by a computing device processor, display of at least one input field configured to receive P2P payment credentials;
receiving, by a computing device processor, a second input that defines P2P payment credentials of the user;
initiating, by a computing device processor, electronic communication of a payment request including a payment amount and the P2P payment credentials;
receiving, by a computing device processor, the electronic communication including the payment request,
in response to receiving the electronic communication:
validating, by a computing device processor, the user as a registered P2P payment participant based on the P2P payment credentials;
determining, by a computing device processor, the payment account designated by the user for paying the payment amount;
determining, by a computing device processor, a payee account for receiving the payment amount; and
initiating, by a computing device processor, immediate remittance of the payment amount from the payment account to the payee account.

17. The method of claim 16, wherein initiating communication of the payment request further comprises initiating, by a computing device processor, electronic communication of a payment request that further identifies the payee account and wherein determining the payee account further comprises determining, by a computing device processor, the payee account as the payee account identified in the payment request.

18. The method of claim 16, wherein initiating communication of the payment request further comprises initiating, by a computing device processor, electronic communication of a payment request the further includes payment attribute data and wherein determining the payee account further comprises determining, by a computing device processor, the payee account based on the payment attribute data.

19. The method of claim 16, further comprising attaching, by a computing device processor, the payment attribute data to remittance of the payment amount from the payment account to the payee account.

20. The method of claim 16, wherein receiving the first input further comprises receiving, at the computing device, the first input from the user that selects the P2P payment widget, wherein the P2P payment widget is one of (1) embedded with a web page such that the widget is displayed as a selectable icon within the web page, or accessible through one (2) a mobile application, (3) an electronic document or (4) a text message.
